(19) United States
(12) Patent Application Publication
(10) Pub. No.: US 2026/0097643 A1
(43) Pub. Date: Apr. 9, 2026

(54) FUEL TANK VALVE SYSTEMS AND METHODS OF ASSEMBLY

(71) Applicant: Eaton Intelligent Power Limited, Dublin 4 (IE)

(72) Inventors: Akash Gonjari, Solapur (IN); Yuvraj Gorwade, Pune (IN); Chandan Mohapatra, Pune (IN)

(21) Appl. No.: 19/411,911

(22) Filed: Dec. 8, 2025

Related U.S. Application Data
(63) Continuation of application No. PCT/IB2024/056354, filed on Jun. 28, 2024.

(30) Foreign Application Priority Data
Jun. 28, 2023 (IN) 202311043337

(51) Int. Cl. B60K 15/035

(52) U.S. Cl. CPC B60K 15/03519; B60K 2015/03542

(57) ABSTRACT

A valve assembly includes a fluid flow passage and valve components configured to selectively close the fluid flow passage. The valve assembly further includes a housing having a first sealing interface and an attachment portion having a second sealing interface. The attachment portion includes an attaching portion configured to couple to an external member to support the valve assembly. The first and second sealing interfaces each include interlocking portions configured to mutually engage with each other to form a seal against fluid communication.

### PRIORITY

This application claims the benefit under 35 U.S. C. § 365(c) of International Patent Application No. PCT/IB2024/056354, filed 28 Jun. 2024, which claims the benefit under 35 U.S. C. § 119(a) of Indian Patent Application No. 202311043337, filed 28 Jun. 2023, the entirety of which are incorporated herein by reference.

### TECHNICAL FIELD

The field of invention relates generally to fuel storage systems for vehicles, and more specifically, to devices that enable safe venting of fuel vapors while preventing unintentional leakage of liquid fuel.

### BACKGROUND

Fuel tanks of vehicles require systems and devices that permit safe, consistent operation under a range of conditions. Reliable performance of these safety systems is particularly critical in view of the high flammability and high energy density of fuel.

For instance, safety systems are needed to ensure that vapors released by the liquid fuel stored within the tank are safely released, rather than allowed to build up pressure within the fuel tank. For instance, a rise in ambient temperature and/or strong solar radiation may raise the temperature of the fuel tank and its contents, increasing the rate of forming fuel vapors.

As another example, if a device or feature for safely allowing vapors of liquid fuels to be released from the tank is provided, further safety features are needed to ensure that the vapor release path does not function as a liquid fuel release or escape path, i.e., to prevent unintentional leakage. For instance, if a tank is over-filled during refueling, liquid fuel level may leak through a passage that is intended for release of fuel vapors, unless the risk is anticipated and mitigated.

As a further example, safety features are needed to ensure that any liquid fuel captured against escape or leakage is safely returned to the fuel tank.

### SUMMARY OF PARTICULAR EMBODIMENTS

The present disclosure relates to features that can enable and improve performance relating to safe venting of fuel vapors from a fuel tank, facilitate sealing against leakage of liquid fuel, and permit recapture and return of liquid fuel undesirably present in the valve assembly back to the fuel tank.

In particular embodiments, a valve assembly includes: a housing including: a fluid flow passage; one or more valve components configured to operate to selectively close the fluid flow passage; and a first sealing interface; and an attachment portion including: an attaching interface disposed along a first surface of the attachment portion and configured to couple to an external member to support the valve assembly; and a second sealing interface disposed along a second surface of the attachment portion opposite the first surface, wherein each of the first sealing interface and the second sealing interface include one or more respective interlocking portions configured to mutually engage with each other to form a seal against fluid communication.

In particular embodiments, which may combine the features of some or all of the above embodiments, the attaching interface includes one or more protrusions directed toward the external member. In particular embodiments, which may combine the features of some or all of the above embodiments, the first sealing interface is disposed on a first portion of the housing, wherein the housing further includes a second portion separately provided from the first portion and disposed opposite to the first portion along a longitudinal axis of the valve assembly.

In particular embodiments, which may combine the features of some or all of the above embodiments, one of the first portion or the second portion includes one or more apertures, wherein the other of the first portion or the second portion includes one or more retaining elements configured to respectively engage with the one or more apertures to couple the second portion and the first portion in an assembled configuration of the housing. In particular embodiments, which may combine the features of some or all of the above embodiments, the housing includes one or more slots provided proximal to a corresponding aperture of the one or more apertures. In particular embodiments, which may combine the features of some or all of the above embodiments, each of the one or more slots passes through a thickness of a wall of the housing. In particular embodiments, which may combine the features of some or all of the above embodiments, the housing includes one or more cut-out portions, and wherein each of the cut-out portions extends to a corresponding aperture of the one or more apertures.

In particular embodiments, which may combine the features of some or all of the above embodiments, the housing includes one or more pairs of longitudinal ribs, and wherein each pair of the one or more pairs of longitudinal ribs surrounds a corresponding aperture of the one or more apertures. In particular embodiments, which may combine the features of some or all of the above embodiments, the housing includes one or more lateral ribs, and wherein each of the one or more lateral ribs is disposed proximal to a side or edge of a corresponding aperture of the one or more apertures. In particular embodiments, which may combine the features of some or all of the above embodiments, at least one of the one or more lateral ribs is interrupted by a slot or a cut-out portion of the housing.

In particular embodiments, which may combine the features of some or all of the above embodiments, one of the first sealing interface or the second sealing interface includes a first projection, a second projection radially separated from the first projection, and a first seal gap disposed between the first projection and the second projection, wherein the other of the first sealing interface or the second sealing interface includes a third projection, a fourth projection radially separated from the first projection, and a second seal gap disposed between the third projection and the fourth projection.

In particular embodiments, which may combine the features of some or all of the above embodiments, the first projection includes a first projection length and the second projection includes a second projection length, wherein the first projection length and the second projection length are measured from a base of the first seal gap to a respective tip of the first projection and the second projection along a longitudinal direction, wherein the third projection includes a third projection length and the fourth projection includes a fourth projection length, and wherein the third projection length and the fourth projection length are measured from a base of the second seal gap to a respective tip of the third projection and the fourth projection along a longitudinal direction.

In particular embodiments, which may combine the features of some or all of the above embodiments, the first seal gap includes a first seal gap width, wherein the base of the first seal gap includes a first radius of curvature such that the first seal gap width is twice the first radius of curvature, wherein the second seal gap includes a second seal gap width, and wherein the base of the second seal gap includes a second radius of curvature such that the second seal gap width is twice the second radius of curvature. In particular embodiments, which may combine the features of some or all of the above embodiments, the first projection length is equal to the second projection length, and wherein the fourth projection length is greater than the third projection length.

In particular embodiments, which may combine the features of some or all of the above embodiments, the fourth projection length is greater than the second projection length. In particular embodiments, which may combine the features of some or all of the above embodiments, the third projection length is less than the first projection length or the second projection length. In particular embodiments, which may combine the features of some or all of the above embodiments, the second projection is wider in a radial or transverse direction than the second seal gap when the first sealing interface is separated from the second sealing interface. In particular embodiments, which may combine the features of some or all of the above embodiments, the third projection is wider in a radial or transverse direction than the first seal gap when the first sealing interface is separated from the second sealing interface.

In particular embodiments, which may combine the features of some or all of the above embodiments, a fuel tank assembly is disclosed, the assembly including: a fuel tank; and a valve assembly installed on the fuel tank, wherein the valve assembly includes: a housing including a fluid flow passage, one or more valve components configured to operate to selectively close the fluid flow passage, and a first sealing interface; and an attachment portion including an attaching interface disposed along a first surface of the attachment portion and configured to couple to an external member to support the valve assembly, and a second sealing interface disposed along a second surface of the attachment portion opposite the first surface, wherein each of the first sealing interface and the second sealing interface include one or more respective interlocking portions configured to mutually engage with each other to form a seal against fluid communication.

In particular embodiments, which may combine the features of some or all of the above embodiments, a method of coupling an attachment portion of a valve assembly to a housing of the valve assembly is disclosed, the method including: aligning the attachment portion of the valve assembly with a first portion of the housing so that a first sealing interface provided on the first portion of the housing engages with one or more respective interlocking portions of a second sealing interface provided on the attachment portion of the valve assembly; and aligning the first portion of the housing to a second portion of the housing so that at least one aperture of the first portion interlocks with at least one retaining element of the second portion and connects the first portion to the second portion, wherein the first portion includes the at least one aperture on one side of the first portion, and wherein the second portion includes the at least one retaining element on one side of the second portion.

In particular embodiments, which may combine the features of some or all of the above embodiments, a valve assembly is disclosed in which a weld pad is coupled or connected to the adaptor directly without using a separate cover. The weld pad may be coupled or connected to the adaptor through a sealing arrangement including a labyrinth structure on the weld pad and one or more slits on the adaptor. The adaptor may have at least one aperture on one side of the adaptor and may have one or more vertical ribs and one or more horizontal ribs on the aperture frame to strengthen the aperture frame. The adaptor may have the material in the areas around the aperture being removed.

In particular embodiments, which may combine the features of some or all of the above embodiments, methods described herein relate to a valve assembly. The valve assembly may include a valve housing having at least one retaining element on one side of the valve housing. The adaptor may include at least one slit on the adaptor, and at least one aperture on one side of the adaptor. The at least one aperture may be configured to interlock with the at least one retaining element of the valve housing to connect the adaptor with the valve housing. The valve assembly may include a weld pad having at least one labyrinth being configured to interlock with the least one slit of the adaptor to seal a contact between weld pad and the adaptor.

In particular embodiments, which may combine the features of some or all of the above embodiments, the adaptor may include one or more ribs surrounding the at least one aperture of the adaptor. The one or more ribs may strengthen the aperture frame associated with the aperture.

In particular embodiments, which may combine the features of some or all of the above embodiments, the one or more ribs may include one or more vertical ribs including a first vertical rib having a first distance to a first edge of the aperture and a second vertical rib having a second distance to a second edge of the aperture.

In particular embodiments, which may combine the features of some or all of the above embodiments, the first vertical rib may be parallel to the first edge of the aperture and the second vertical rib is parallel to the second edge of the aperture. In particular embodiments, which may combine the features of some or all of the above embodiments, the aperture may be between the first vertical rib and the second vertical rib. In particular embodiments, which may combine the features of some or all of the above embodiments, the aperture may be at a center position with respect to the first vertical rib and second vertical rib. In particular embodiments, which may combine the features of some or all of the above embodiments, the one or more ribs may include one or more horizontal ribs. In particular embodiments, which may combine the features of some or all of the above embodiments, the one or more horizonal ribs may include a first horizontal rib and a second horizontal rib.

In particular embodiments, which may combine the features of some or all of the above embodiments, the first horizontal rib and the second horizontal rib may be along a same horizontal line. In particular embodiments, which may combine the features of some or all of the above embodiments, the adaptor may have a slot under the aperture. The slot may be a through slot or a non-through slot. The slot may strengthen the aperture frame associated with the aperture and may increase flexibility of the aperture frame associated with the aperture. In particular embodiments, which may combine the features of some or all of the above embodiments, the slot may be between the first horizontal rib and the second horizontal rib.

In particular embodiments, which may combine the features of some or all of the above embodiments, the material around the aperture may be removed from the adaptor. In particular embodiments, which may combine the features of some or all of the above embodiments, the adaptor may have a seal structure that couples the weld pad to the adaptor. In particular embodiments, which may combine the features of some or all of the above embodiments, the seal structure may include an inner slit and an external slit. The inner slit may be within the external slit. The inner slit and the external slit may extend or protrude to a height from a surface of the adaptor.

In particular embodiments, which may combine the features of some or all of the above embodiments, the inner slit and the external slit may form an open in-between. In particular embodiments, which may combine the features of some or all of the above embodiments, the open between the inner slit and the external slit may have a first width at a first position greater than a second width at a second position. The second position may be closer to the body portion of the adaptor than the first position.

In particular embodiments, which may combine the features of some or all of the above embodiments, the labyrinth and the at least one slit may form a sealing arrangement that seals a contact between the weld pad and the adaptor. In particular embodiments, which may combine the features of some or all of the above embodiments, the labyrinth may include a first projection and a second projection. The first projection may extend or protrude from a surface of the weld pad to a first height. The second projection may extend or protrude from the surface of the weld pad to a second height. In particular embodiments, which may combine the features of some or all of the above embodiments, the second height may be greater than the first height. The first projection and the second projection may be coupled to the adaptor through a seal structure of the adaptor.

In particular embodiments, which may combine the features of some or all of the above embodiments, the techniques described herein relate to a fuel tank assembly, including: a fuel tank, a valve assembly installed on the fuel tank, an adaptor, and a weld pad. The valve assembly may include a valve housing having at least one retaining element on one side of the valve housing. The adaptor may include at least one slit on the adaptor, and at least one aperture on one side of the adaptor. The at least one aperture may be configured to interlock with the at least one retaining element of the valve housing to connect the adaptor with the valve housing. The valve assembly may include a weld pad having at least one labyrinth being configured to interlock with the least one slit of the adaptor to seal a contact between weld pad and the adaptor.

In particular embodiments, which may combine the features of some or all of the above embodiments, the techniques described herein relate to a method of coupling a weld pad to a valve assembly, including: moving the weld pad to an adaptor of the valve assembly until a labyrinth of the weld pad interlocks with at least one slit of the adaptor and seals a contact between the weld pad and the adaptor; and moving the adaptor to a valve housing of the valve assembly until at least one aperture of the adaptor interlocks with at least one retaining element of the valve housing and connects the adaptor to the valve housing. The adaptor may include the at least one aperture on one side of the adaptor, and the valve housing may include the at least one retraining element on one side of the valving housing. The weld pad may include the labyrinth. The adaptor may include the at least one slit.

### BRIEF DESCRIPTION OF THE DRAWINGS

The present invention will be described in greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 illustrates a schematic exemplary fuel tank assembly, according to particular embodiments.

FIG. 2 illustrates a schematic exemplary valve assembly with a separate cover, according to particular embodiments.

FIG. 3 illustrates a schematic exemplary valve assembly without a separate cover, according to particular embodiments.

FIG. 4A illustrates a schematic exemplary sealing arrangement, according to particular embodiments.

FIG. 4B illustrates an enlarged schematic view of the sealing arrangement of FIG. 4A, according to particular embodiments.

FIG. 4C illustrates a schematic bottom view of an exemplary sealing arrangement, according to particular embodiments.

FIGS. 5A and 5B illustrate schematic perspective views of exemplary valve assembly adaptors, according to particular embodiments.

FIGS. 5C and 5D illustrate schematic perspective views of exemplary valve assembly adaptors with additional material removed relative to the examples of FIGS. 5A and 5B, according to particular embodiments.

FIG. 5E illustrates a schematic exemplary adaptor depicting ribs, according to particular embodiments.

FIGS. 5F and 5G illustrate schematic exemplary designs for a slot of an adaptor, according to particular embodiments.

FIG. 6 illustrates an exploded schematic view of a valve assembly, according to particular embodiments.

### DESCRIPTION OF EXAMPLE EMBODIMENTS

To facilitate a better understanding of the present disclosure, the following examples of certain embodiments are given. The following examples are not to be read to limit or define the scope of the disclosure. In accordance with various embodiments of the present disclosure, various mechanisms, assemblies, arrangements, and methods of assembly, manufacture, and/or operation of fuel tank valve systems are disclosed herein.

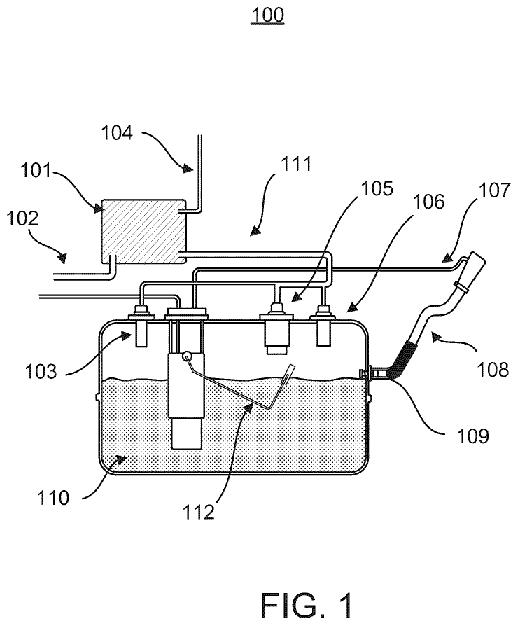

With reference to the figures, FIG. 1 illustrates a schematic exemplary fuel tank assembly, according to particular embodiments. By way of example and not limitation, a valve assembly may be provided as a separable and/or attachable module of a fluid tank assembly, such as a fuel tank assembly 100 depicted in FIG. 1. In particular embodiments, a valve assembly, e.g., valve assembly 105, may be fluidly connected to contents of a tank, such as liquid and/or vapor contents. In particular embodiments, the tank may be configured as a fuel tank, such as fuel tank 110 of a fuel tank assembly 100 depicted in FIG. 1 by way of example and not limitation. In particular embodiments, the valve assembly 105 may be internally or externally mounted relative to fuel tank 110. In particular embodiments, valve assembly 105 may be coupled to tank 110 and/or to other modules or subsystems via one or more suitable flanges or adapters.

In particular embodiments, fuel tank assembly 100 may include a fuel tank 110 for storage of liquid fuel. In particular embodiments, fuel tank assembly 100 may include one or more valve assemblies, such as valve assembly 105, mounted to fuel tank 110. By way of example and not limitation, valve assembly 105 may comprise a fill limit vent valve (FLVV). In particular embodiments, such as in fuel tank applications by way of non-limiting example, The valve assembly 105 may be connected to a canister 101 through a first fuel pipe 111. The canister 101 may be connected to an engine by a second fuel pipe 104 and may have a third pipe 102 for allowing air to come into the canister 101. The fuel tank assembly 100 may separately or additionally comprise a grade vent valve (GVV) 103 mounted to the fuel tank 110 and connected to the canister 101 through the first fuel pipe 111. The fuel tank assembly 100 may include a float 112 for measuring the fuel level in the fuel tank 110. The fuel tank assembly 100 may include a rollover valve (ROV) 106 which is amounted to the fuel tank 110 and connected to the canister 101 through the first fuel pipe 111. The fuel tank assembly 100 may include an inlet check valve (ICV) 109 which is amounted to the fuel tank 110 and connected to other components of the fuel tank assembly 100 through a smaller diameter fill tube 108 and a recirculating tube 107. The fill limit vent valve (FLVV) 105 may be a venting valve for the fuel tank 110 to vent out fuel vapor and control the fill level in the fuel tank 110. The valve assembly 105 may be mounted over the fuel tank 110 as shown in FIG. 1. By way of example and not limitation, functions of the valve assembly 105 may include venting fuel vapors and/or limiting fill level.

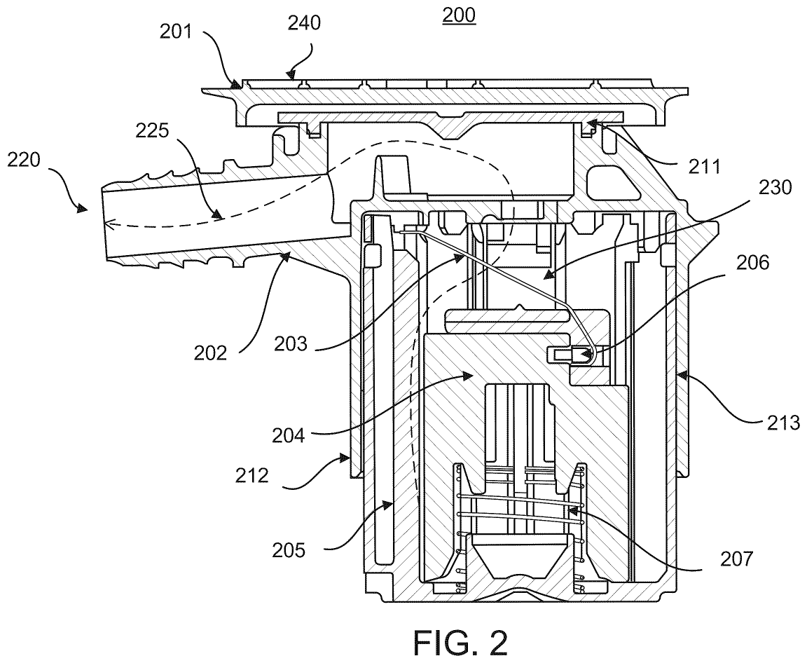

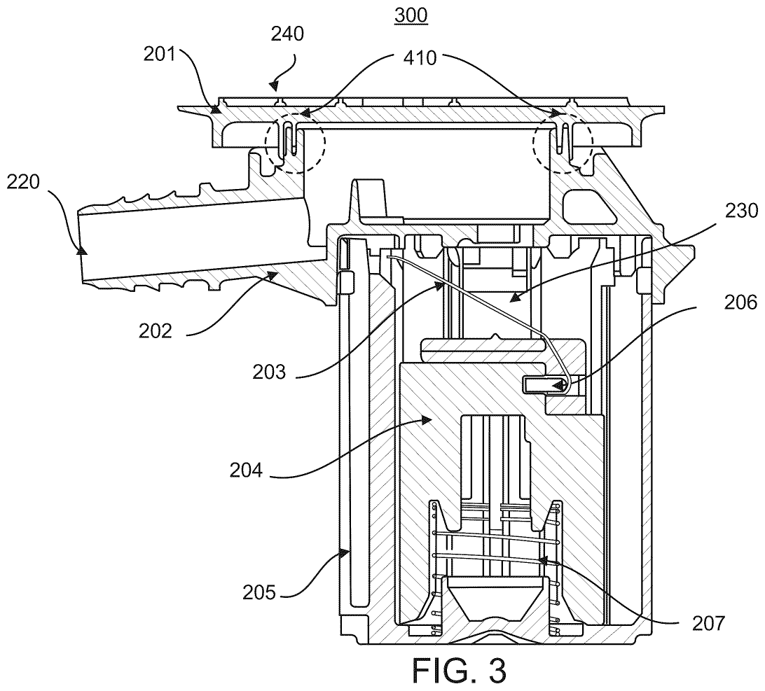

FIGS. 2 and 3 illustrate schematic exemplary valve assemblies, according to particular embodiments. In particular embodiments, valve assembly 105 may be provided with an outlet port, such as outlet port 220. By way of example and not limitation, the outlet port may be configured as an outlet conduit for vapors released by the tank, such as for release or escape of fuel vapors (for e.g., to another module or valve subsystem, and/or to a carbon canister).

In particular embodiments, valve assembly 105 may comprise a fluid flow passage, such as bore 230. In particular embodiments, the bore may be centrally and/or symmetrically located within the housing of valve assembly 105. In particular embodiments, the bore may be non-centrally located within valve assembly 105. By way of example and not limitation, such as depicted in FIGS. 2 and 3, the bore 230 may be provided along a longitudinal axis of valve assembly 105. In particular embodiments, an upper portion of the fluid passage of valve assembly 105 may be provided in fluid communication with an outlet port 220 of the valve assembly.

In particular embodiments, one or more components of valve assembly 105 may be configured to selectively close a suitable passage, such as bore 230, based on meeting on or more fluid, flow, and/or tank conditions, such as based on a liquid level present in the tank reaching a predetermined level (for e.g., a maximum level). By way of example and not limitation, such as illustrated in FIGS. 2 and 3, valve assembly 105 may comprise a suitable mechanism, such as a float assembly, configured to rise and fall responsive to a liquid level within the tank. Continuing by way of non-limiting example, a suitable mechanism (e.g., a float assembly comprising float 204) can be configured to close off a bore or other passage opening (e.g., exemplary fluid flow pathway 225) when the liquid level reaches a maximum. By way of example and not limitation, such as illustrated in FIG. 2, valve assembly 105 may alternatively or additionally comprise a ribbon or membrane (e.g., ribbon 203) configured to close and/or seal the bore opening based on liquid level.

In particular embodiments, valve assembly 105 may include an attachment portion 201. By way of example and not limitation, attachment portion 201 may comprise a weld pad, such as may be configured for attachment by polymer joining processes, for e.g., ultrasonic welding. In particular embodiments, a housing of valve assembly 105 may include multiple portions configured to be coupled during assembly. By way of example and not limitation, a housing of valve assembly 105 may include a first housing portion 202 and a second housing portion 205. In particular embodiments, first housing portion 202 may comprise an adaptor such as depicted in at least FIGS. 2 and 3 by way of non-limiting example. In particular embodiments, one or both of first housing portion 202 and/or second housing portion 205 may enclose other valve components. By way of example and not limitation, one or more of a ribbon 203, a float 204, a clip 206, and/or a spring 207 may be so contained or enclosed.

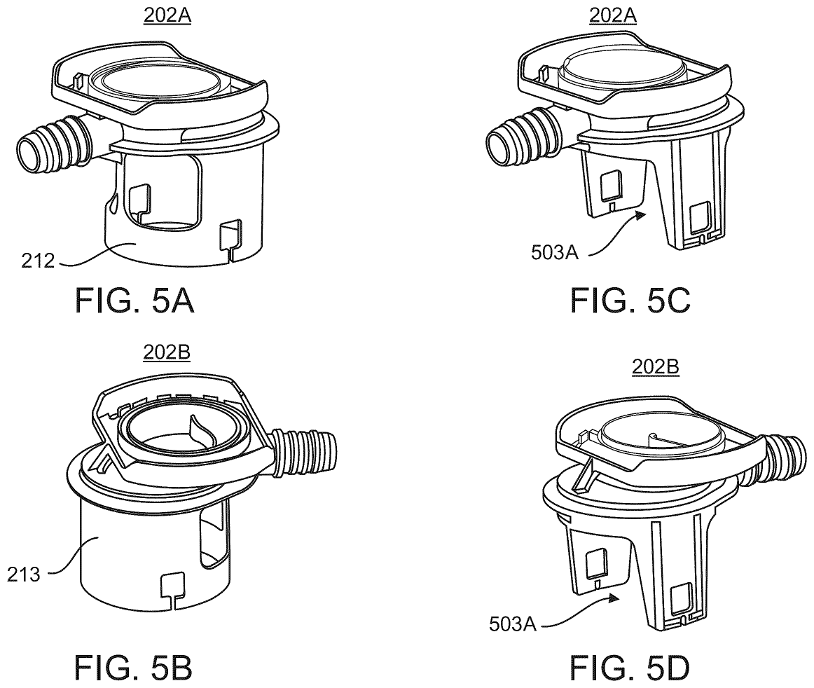

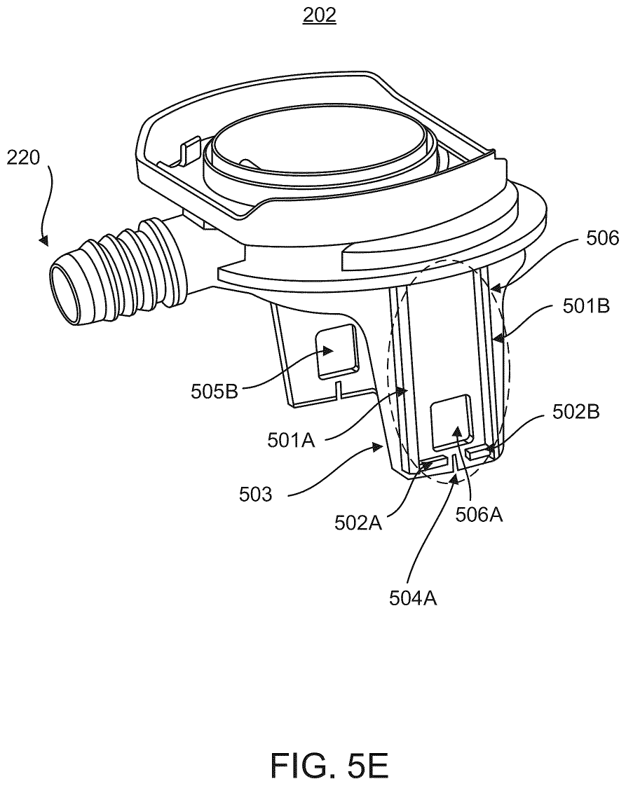

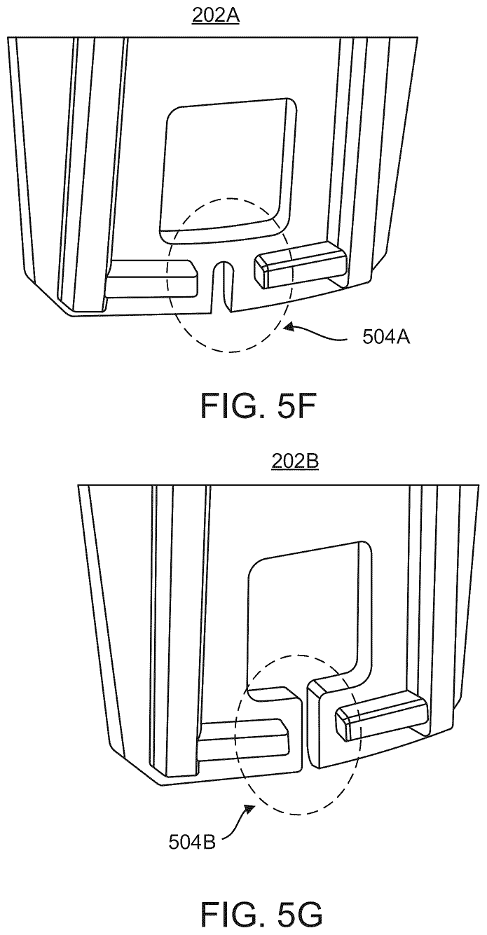

In particular embodiments, such as depicted in FIG. 2 by way of example and not limitation, valve assembly 105 may include a cover 211. In particular embodiments, such as depicted in FIGS. 2, 5A, and 5B by way of example and not limitation, first housing portion 202 may include a first adaptor portion 212 and/or a second adaptor portion 213, one or both of which may be attached to, and/or cover, portions of an external surface of the housing when the first housing portion 202 is assembled with the second housing portion 205.

In particular embodiments, such as depicted in FIG. 3 by way of example and not limitation, attachment portion 201 may be directly coupled to a suitable portion of valve assembly 105, such as first housing portion 202. In particular embodiments, attachment portion 201 may be structured and configured to mechanically support and attach particular portions of valve assembly 105 to an external support member, such as a fuel tank wall. In particular embodiments, attachment portion 201 may be structured and configured to fluidly seal internal fluid flow and passages of valve assembly 105 relative to an environment outside valve assembly 105. In particular embodiments, such as depicted in FIG. 3 by way of example and not limitation, attachment portion 201 may comprise a unitary or integral structural configured to perform both the structural support and fluid sealing functions discussed above.

In particular embodiments, attachment portion 201 may be coupled or connected to the first housing portion 202 through a sealing arrangement 410. In particular embodiments, sealing arrangement 410 may comprise a suitable sealing interface provided on a suitable housing portion of valve assembly 105. By way of example and not limitation, sealing arrangement 410 may include a first sealing interface 401 provided on first housing portion 202 of valve assembly 105. In particular embodiments, sealing arrangement 410 may separately or additionally comprise a suitable sealing interface provided on attachment portion 201. By way of example and not limitation, a second sealing interface 402 may be provided on attachment portion 201. In particular embodiments, one or both of first sealing interface 401 and/or second sealing interface 402 may include a labyrinthine structure. In particular embodiments, each of first sealing interface 401 and second sealing interface 402 may comprise one or more respective interlocking portions configured to mutually engage with each other to form a seal against fluid communication.

In particular embodiments, attachment portion 201 may comprise an attaching interface 240 disposed on or along a surface of attachment portion 201 that may be provided opposite a first surface of attachment portion 201 having second sealing interface 402. In particular embodiments, attaching interface 240 may be configured to couple to an external member to support one or more parts of valve assembly 105. In particular embodiments, such as depicted in FIGS. 2, 3, and/or 6 by way of example and not limitation, attaching interface 240 may comprise one or more outward-directed protrusions configured for coupling to an external support member, such as a fuel tank wall or other suitable structure.

It will be appreciated that while particular structural details and operating principles of a valve assembly are provided here for ease of understanding, it should be appreciated that other embodiments of valve assemblies, e.g., those that may differ structurally and/or functionally, may be deployed stand-alone or in combination with an attachment portion and/or other features presently disclosed, and are fully contemplated herein in any suitable combination.

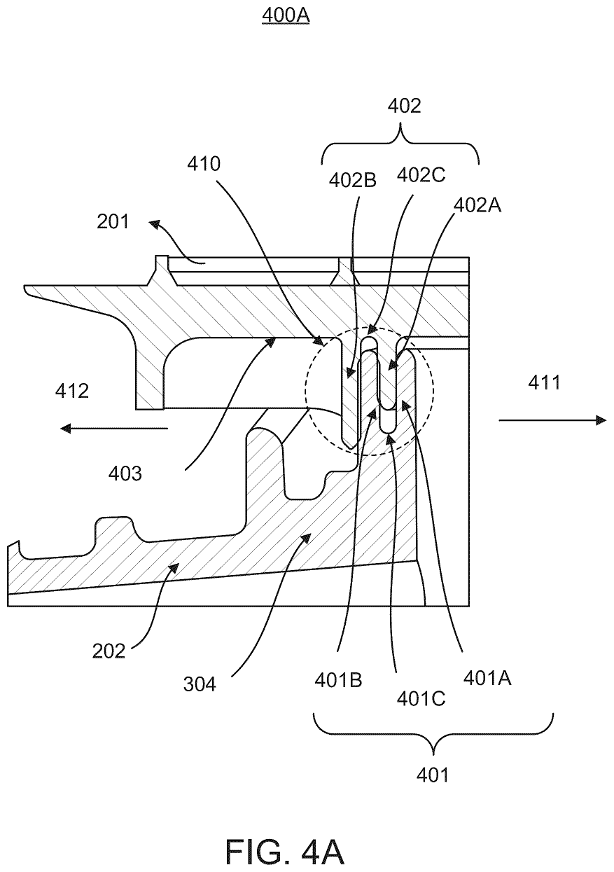

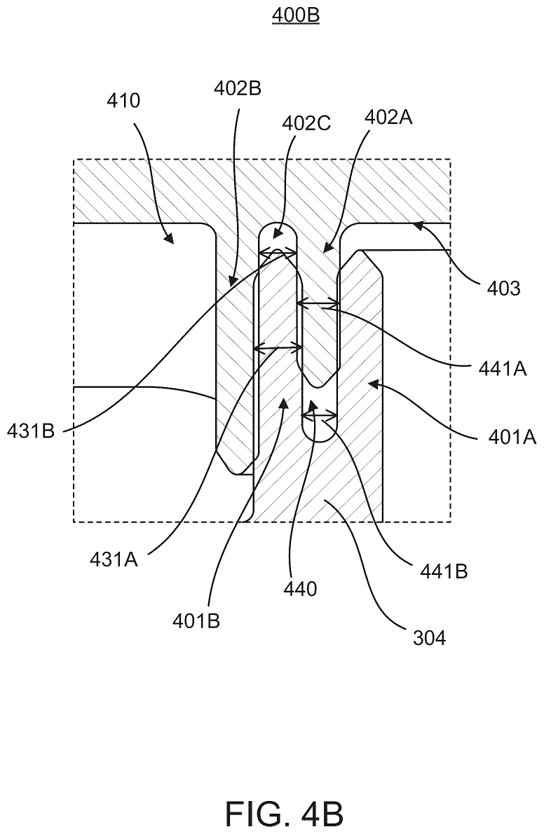

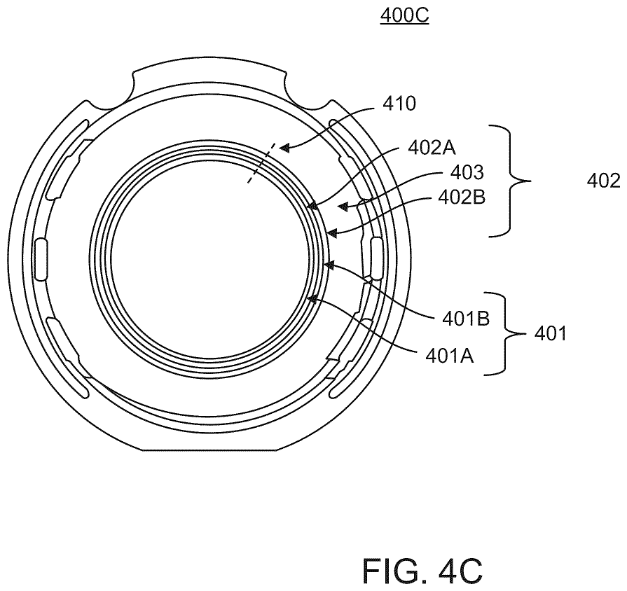

FIG. 4A illustrates a schematic exemplary sealing arrangement, according to particular embodiments. FIG. 4B illustrates an enlarged schematic view of the sealing arrangement of FIG. 4A, according to particular embodiments. FIG. 4C illustrates a schematic bottom view of an exemplary sealing arrangement, according to particular embodiments.

In particular embodiments, sealing arrangement 410 may include a first sealing interface 401 that may be attached to, and/or a part of, a suitable portion of valve assembly 105, such as first housing portion 202. In particular embodiments, first sealing interface 401 may include a first projection 401A and a second projection 401B, as schematically depicted in FIGS. 4A and 4B by way of example and not limitation. In particular embodiments, first projection 401A and/or second projection 401B may comprise a wall-like structure. In particular embodiments, first projection 401A and/or second projection 401B may extend from body portion 304. In particular embodiments, first sealing interface 401 may comprise a first seal gap 401C disposed between first projection 401A and second projection 401B. In particular embodiments, such as with reference to cylindrical or other curved or curvilinear section structures by way of example and not limitation, first projection 401A may be radially separated from second projection 401B, for e.g., by first seal gap 401C.

In particular embodiments, sealing arrangement 410 may include a second sealing interface 402 that may be attached to, and/or a part of, attachment portion 201. In particular embodiments, second sealing interface 402 may include a third projection 402A and a fourth projection 402B, as schematically depicted in FIGS. 4A and 4B by way of example and not limitation. In particular embodiments, third projection 402A and/or fourth projection 402B may comprise a wall-like structure. In particular embodiments, third projection 402A and/or fourth projection 402B may extend from a surface 403 of attachment portion 201. In particular embodiments, second sealing interface 402 may comprise a second seal gap 402C disposed between third projection 402A and fourth projection 402B. In particular embodiments, such as with reference to cylindrical or other curved or curvilinear section structures by way of example and not limitation, third projection 402A may be radially separated from fourth projection 402B, for e.g., by second seal gap 402C.

It should be appreciated that while particular numbering, such as “first,” “second,” “third,” and/or “fourth,” may be used herein to indicate references and to otherwise provide a better understanding, no dependencies or other relationships such as to other numerical descriptors are implied, and as such should not be assumed or so ascribed unless otherwise indicated herein. By way of example and not limitation, the presence of a third projection and/or fourth projection do not suggest or require a first and/or second projection per se; they are merely labels for illustrative purposes.

In particular embodiments, one or more of projections 401A, 401B, 402A, and/or 402B may form a corresponding closed-loop and/or curved structure in particular views such as a top or bottom view, e.g., a circle-like or circular structure such as depicted in FIG. 4C by way of example and not limitation. In particular embodiments, one or more of projections 401A, 401B, 402A, and/or 402B may form a corresponding hollow cylinder-like structure, wherein each circle-like structure may have a characteristic offset length as a cylinder height, as described above. In particular embodiments, first projection 401A may have a smaller diameter than the second projection 401B, and may be contained within the second projection 401B. In particular embodiments, third projection 402A may have a smaller diameter than fourth projection 402B, and may be contained within fourth projection 402B.

As depicted in FIGS. 4A and 4B by way of non-limiting example, in particular embodiments, sealing arrangement 410 may include first sealing interface 401 attached to or as a part of a suitable portion of valve assembly 105, such as first housing portion 202. In particular embodiments, first sealing interface 401 may include first projection 401A and second projection 401B, having a gap therebetween. In particular embodiments, first sealing interface 401 may be referred to as a “seal ring” and/or a “seal ring structure.” In particular embodiments, first projection 401A may extend from body portion 304 of first housing portion 202 to a first height. In particular embodiments, second projection 401B may extend from the body portion 304 of first housing portion 202 to a second height. In particular embodiments, first projection 401A and second projection 401B may each comprise a corresponding projection length measured along a longitudinal direction from a base of first seal gap 401C to a respective projection tip.

In particular embodiments, such as depicted in FIGS. 4A and 4B by way of example and not limitation, first projection 401A and second projection 401B may have the same height and/or the same projection length. In particular embodiments, first projection 401A and second projection 401B may have different heights and/or projection lengths.

In particular embodiments, third projection 402A may extend from attachment portion 201 to a third height, or third projection length. In particular embodiments, fourth projection 402B may extend from attachment portion 201 to a fourth height, or fourth projection length. By way of example and not limitation, such heights or projection length may be measured from a suitable datum, such as surface 403, or the base of second seal gap 402C, to a tip of the corresponding projection. In particular embodiments, the third projection length and the fourth projection length may be measured from a base of second seal gap 402C to a respective tip of third projection 402A and fourth projection 402B along a longitudinal direction. In particular embodiments, third projection 402A and fourth projection 402B may have the same height and/or the same projection length. In particular embodiments, third projection 402A and fourth projection 402B may have different heights and/or projection lengths.

In particular embodiments, fourth projection 402B may have a longer projection length than third projection 402A. In particular embodiments, fourth projection 402B may have a longer projection length than the respective projection lengths of first projection 401A and/or second projection 401B. In particular embodiments, a projection length of third projection 402A is less than the respective projection lengths of first projection 401A and/or second projection 401B.

In particular embodiments, first projection 401A and second projection 401B may together form a second sealing interface 402 that may be directly coupled to the first sealing interface 401 provided on a suitable portion of valve assembly 105, such as first housing portion 202. In particular embodiments, first projection 401A and second projection 401B may have first seal gap 401C therebetween. In particular embodiments, first seal gap 401C may have non-uniform width along its longitudinal extent. By way of example and not limitation, first seal gap 401C may be wider at a first end that is farther from body portion 304 than at a second end closer to the body portion 304. In particular embodiments, by way of non-limiting example, first seal gap 401C may have a first width at a first position 441A greater than a second width at a second position 441B, where the first position has a greater distance to body portion 304 than the second position. In particular embodiments, first projection 401A and/or second projection 401B may have a uniform thickness. In particular embodiments, first projection 401A and second projection 401B may have non-uniform thickness. By way of example and not limitation, a thickness of first projection 401A and/or second projection 401B at an end that is farther from body portion 304 of first housing portion 202 may be thinner than the thickness at the end that is closer to the body portion 304 of first housing portion 202. In particular embodiments, a thickness of first projection 401A and/or 401B may gradually decrease from the end that is closer to the body portion 304 first housing portion 202 to the other end that is farther to the body portion 304 of first housing portion 202.

As schematically illustrated in FIG. 4B by way of example and not limitation, second seal gap 402C between third projection 402A and fourth projection 402B may have non-uniform width along its longitudinal extent, e.g., perpendicular to the surface 403, in particular embodiments. By way of example and not limitation, second seal gap 402C may be wider at the farther end from the surface 403 than at closer end proximal to the surface 403, in particular embodiments. In particular embodiments, second seal gap 402C may have a first width 431A at a first position that is greater than a second width 431B at a second position, where the first position has a greater distance to the surface 403 than the second position. In particular embodiments, third projection 402A and/or fourth projection 402B may have a uniform thickness along the dimension parallel to the surface 403 but have different heights along the dimension perpendicular to the surface 403. In particular embodiments, third projection 402A and/or fourth projection 402B may have a non-uniform thickness. By way of example and not limitation, a thickness at the end that is farther from the surface 403 may be thinner than the thickness at the end is closer to the surface 403. By way of example and not limitation, a thickness of third projection 402A and/or fourth projection 402B may gradually decrease from the end that is closer to the surface 403 to the other end that is farther to the surface 403.

In particular embodiments, first seal gap 401C comprises a first seal gap width proximal to the base of first seal gap 401C. In particular embodiments, the base of first seal gap 401C comprises a first radius of curvature such that the first seal gap width is twice the first radius of curvature. In particular embodiments, second seal gap 402C comprises a second seal gap width proximal to the base of second seal gap 402C. In particular embodiments, the base of second seal gap 402C comprises a second radius of curvature such that the second seal gap width is twice the second radius of curvature.

In particular embodiments, such as depicted in FIG. 4A by way of example and not limitation, first sealing interface 401 and second sealing interface 402 may be directly coupled. By way of example and not limitation, once coupled, third projection 402A may be contained within the first seal gap 401C between first projection 401A and second projection 401B, for e.g., of first housing portion 202. By way of example and not limitation, third projection 402A may be disposed between second projection 401B and first projection 401A when attachment portion 201 is coupled to first housing portion 202, in particular embodiments. In particular embodiments, an inward surface of the third projection 402A may make physical contact and apply a force against an outward surface of first projection 401A, wherein “inward surface” and “outward surface” may be referenced based on whether the corresponding surface faces an inner direction 411 or outer direction 412, as illustrated in FIG. 4A. By way of example and not limitation, a surface facing the inner direction 411 may be referred to as an “inward surface” and a surface facing the outer direction 412 may be referred to as an “outward surface.” By way of example and not limitation, the inward surface of the third projection 402A and the outward surface of first projection 401A may contact each other and apply a force against each other to strengthen the coupling between attachment portion 201 and first housing portion 202. By way of example and not limitation, the outward surface of third projection 402A and the inward surface of the second projection 401B may physically contact each other and apply a force against each other to strengthen the coupling between attachment portion 201 and first housing portion 202.

By way of example and not limitation, when the attachment portion 201 is coupled to first housing portion 202, the second projection 401B may be contained within second seal gap 402C between third projection 402A and fourth projection 402B. By way of example and not limitation, the inward surface of second projection 401B may have a physical contact and apply a force against the outward surface of the third projection 402A. By way of example and not limitation, the inward surface of the second projection 401B and the outward surface of the third projection 402A may contact each other and apply a force against each other to strengthen the coupling between the attachment portion 201 and first housing portion 202. By way of example and not limitation, the outward surface of second projection 401B and the inward surface of fourth projection 402B may physically contact each other and apply a force against each other to strengthen the coupling between attachment portion 201 and first housing portion 202.

In particular embodiments, third projection 402A may have a shape that is consistent and fits to the shape of open first seal gap 401C between first projection 401A and second projection 401B. By way of example and not limitation, if the open first seal gap 401C between first projection 401A and second projection 401B has a gradually changing width, third projection 402A may be configured with a gradually changing width to fit the open first seal gap 401C. By way of example and not limitation, if the open first seal gap 401C has a width that changes steeply at one or more positions, third projection 402A may have a steeply changing width to fit the open first seal gap 401C. In other words, the engaging surfaces that contact and apply a force against each other may be consistent in the surface shapes and fit to each other, in particular embodiments. By way of example and not limitation, the inward surface of third projection 402A and the outward surface of first projection 401A may have the surfaces shapes that are consistent and fitting to each other. As another non-limiting example, the outward surface of third projection 402A and the inward surface of second projection 401B may have the surface shapes that are consistent and fitting to each other. Similarly, in particular embodiments, second projection 401B may be configured with a shape that is consistent and fits to the shape of the open second seal gap 402C between third projection 402A and fourth projection 402B.

FIGS. 5A-5D illustrate schematic perspective views of exemplary valve assembly adaptors, according to particular embodiments. By way of example and not limitation, such as depicted in FIG. 2 and FIGS. 5A-5B, in particular embodiments, first housing portion 202 may have a first adaptor portion 212 and/or a second adaptor portion 213. By way of example and not limitation, such as depicted in FIGS. 5C and 5D in contrast, in particular embodiments, first housing portion 202 may have material removed in particular areas for e.g., 503A and 503B proximal to the apertures provided on first housing portion 202. In particular embodiments, first housing portion 202 may be constructed to a more desirable balance of stiffness, selective flexibility for assembly and/or energy absorption, weight, and/or cost by removing the material in such areas. By way of example and not limitation, first housing portion 202 may comprise stronger and/or more flexible or elastic aperture frames (e.g., the aperture frame 506 of FIG. 5E) based on such construction techniques. In particular embodiments, stronger aperture frames 506 may strengthen a coupling between attachment portion 201 and first housing portion 202, during assembly and installation, and/or improve their mutual structural integrity and resilience once assembled. In particular embodiments, particular aspects of a design of aperture frame 506 may allow an easier installation process for the first housing portion 202 to be coupled to second housing portion 205, and/or improve their mutual structural integrity and resilience once assembled.

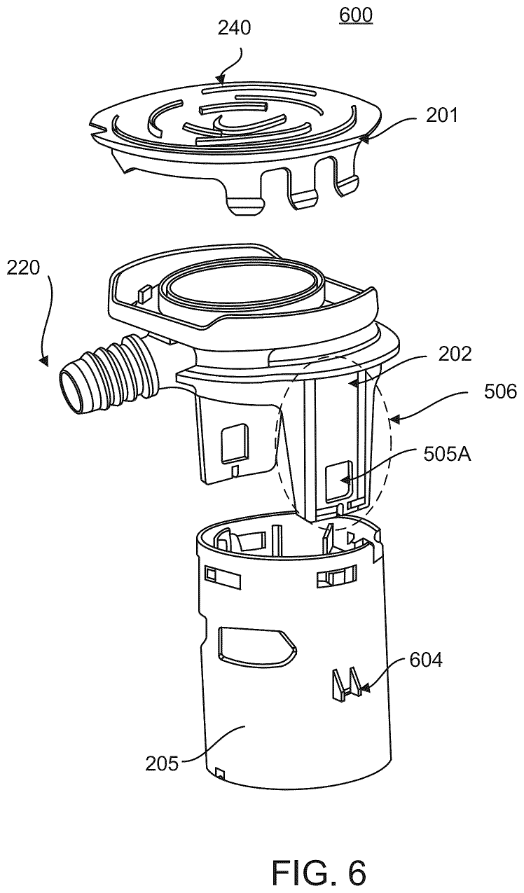

In particular embodiments, first housing portion 202 may be provided with one or more structural ribs to strengthen an aperture frame 506, such as illustrated in FIGS. 5C-5E by way of non-limiting example. In particular embodiments, first housing portion 202 may include a plurality of apertures, such as aperture 505A and aperture 505B disposed on opposite sides of the first housing portion 202, as depicted in FIG. 5E. In particular embodiments, material within the aperture areas may be removed to make the apertures, such as aperture 505A and apertures 505B. By way of example and not limitation, aperture 505A may allow a retaining element (e.g., retaining element 604 depicted in FIG. 6) on second housing portion 205 to snap into the corresponding aperture to couple the first housing portion 202 to second housing portion 205 of valve assembly 105. In particular embodiments, first housing portion 202 may be provided with one or more retaining elements 604. In particular embodiments, second housing portion 205 may be provided with one or more corresponding apertures 505 to engage and couple with first housing portion 202.

In particular embodiments, first housing portion 202 may comprise an aperture frame 506 configured to engage and hold the second housing portion 205 of valve assembly 105. In particular embodiments, the aperture frame 506 may be elastic and flexible to allow deformation during the process when first housing portion 202 is being coupled to the second housing portion 205.

In particular embodiments, first housing portion 202 may include one or more ribs on one or more surfaces of the aperture frames (e.g., aperture frame 506). In particular embodiments, the one or more ribs may include one or more vertical and/or longitudinal ribs. In particular embodiments, the one or more ribs may include one or more horizontal or lateral or circumferential ribs. In particular embodiments, adaptor 302 may include a first longitudinal rib 501A on a first side of the aperture 505A. In particular embodiments, the first longitudinal rib 501A may have a first distance to a first edge of the aperture 505A and may be parallel to the first edge of the aperture 505A. In particular embodiments, first housing portion 202 may include a second longitudinal rib 501B on a second side of the aperture 505A. In particular embodiments, the second longitudinal rib 501B may have a second distance to a second edge of the aperture 505A and may be parallel to the second edge of the aperture. In certain embodiments, the aperture 505 may be square or rectangular. In particular embodiments, aperture 505 may comprise one or more rounded corners. In particular embodiments, the first edge and the second edge of the aperture 505 as described above may be parallel to each other.

In particular embodiments, first housing portion 202 may include one or more lateral ribs on one or more surfaces of the aperture frame 506. In particular embodiments, first housing portion 202 may have a first lateral rib 502A and a second lateral rib 502B, as illustrated in FIG. 5 by way of example and not illustration. In particular embodiments, the first lateral rib 502A may be in a first area under an aperture (e.g., aperture 506A), and/or may be connected to the first longitudinal rib 501A. In particular embodiments, the second lateral rib 502B may be in a second area under the aperture 505A and have a distance to the bottom edge of the aperture 505A. In particular embodiments, the second lateral rib 502B may be connected to the second longitudinal rib 501B and may have distance to the bottom edge of the aperture 505A. In particular embodiments, the first lateral rib 502A and the second lateral rib 502B may be oriented along or disposed on the same horizontal line with respect to each other.

In particular embodiments, first housing portion 202 may comprise a non-through slot 504A, such as between the first lateral rib 502A and the second lateral rib 502B, as depicted in FIGS. 5E and 5F by way of example and not limitation. In particular embodiments, slot 504A may be a midway slot under the aperture 505A and may have a height that is less than the bottom edge of the aperture frame. In particular embodiments, slot 504A may not reach the aperture 505A. In particular embodiments, slot 504A may have a height along a longitudinal or vertical dimension that is greater than the width of the horizontal ribs 502A and 502B, their width being along the longitudinal or vertical dimension. In particular embodiments, slot 504A may be provided below the window to strengthen the aperture frame and to increase flexibility of the aperture frame during the installation process of the snap tab assembly.

In particular embodiments, first housing portion 202 may have a through slot 504B between the first lateral rib 502A and the second lateral rib 502B, such as depicted in FIG. 5G by way of non-limiting example. In particular embodiments, the through slot 504B may be a midway slot under the aperture 505A and may have a height that is equal to or greater than the bottom edge of the aperture frame. In particular embodiments, the through slot 504B may reach the aperture 505A. In certain embodiments, the through slot 504B may have a height along a longitudinal or vertical dimension that is greater than the width of the horizontal ribs 502A and 502B, their width being along the longitudinal or vertical dimension, and the bottom edge of the aperture frame. In particular embodiments, the through slot 504B may be provided below the window to strengthen the aperture frame and to increase flexibility of the aperture frame during the installation process of the snap tab assembly.

FIG. 6 illustrates an exploded schematic view of a valve assembly, according to particular embodiments. By way of example and not limitation, FIG. 6 depicts an exemplary attachment portion 201 and first housing portion 202. In particular embodiments, attachment portion 201 may be coupled to the first housing portion 202 through first sealing interface 401 and second sealing interface 402, such as shown in FIGS. 3 and 4 by way of non-limiting example. In particular embodiments, first housing portion 202 may be coupled to the second housing portion 205 of valve assembly 105 based on mutually engaging the aperture frame 506 and the aperture 505A. Once coupled, in particular embodiments, the retaining element 604 may be disposed within the aperture 505A, and the aperture frame 506 may be coupled to second housing portion 205.

### Miscellaneous

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. For example, it is possible that each of the characteristics described in one of the examples of an embodiment can be combined with one or a plurality of other desired characteristics from other embodiments, resulting in other embodiments that may not be described in words or by reference to the drawings, but which are fully contemplated. It will also be understood that changes and modifications may be made by those of ordinary skill within the scope of the disclosure, illustrations, and/or the following claims. Such variations are fully contemplated herein and not to be regarded as a departure from the disclosure, and all such modifications are intended to be included within the scope of the disclosure.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

It should be noted that figures provided herein may be illustrated schematically rather than literally or precisely; components and aspects of the figures may not necessarily be to scale. Moreover, while like reference labels or numerals may designate corresponding parts throughout the different views in many cases, like parts may not always be provided with like reference numerals or labels in each view. Further, like parts may not be labeled in every view or figure. Numerical ranges recited in this application should be construed to be inclusive of the end points of the stated ranges. Particular axes, such as one or more rotational, lateral and/or longitudinal axes, which may be omitted herein in some illustrations, should be construed to exist in every illustration or situation where it is referred to, or to which it reasonably corresponds. Directional descriptors or references, such as “top,” “bottom,” “upper,” “lower,” “left,” or “right,” among others, are provided herein for ease of reference and are not limiting of the embodiments disclosed herein, whether in isolation or when assembled or installed.

1. A valve assembly for a fuel tank, the valve assembly comprising:
a housing comprising:
a first housing portion including an outlet port and an adaptor, and
a second housing portion configured to be at least partially received within the adaptor so as to couple the first and second housing portions to each other, the second housing portion defining a fluid flow passage in fluid communication with the outlet port;
at least one valve component arranged within the housing, the at least one valve component configured to selectively close the fluid flow passage; and
an attachment portion directly coupled to the first housing portion through a sealing arrangement on a side opposite to the adaptor, the attachment portion configured to (i) couple the valve assembly to a wall of the fuel tank, and (ii) fluidly seal the valve assembly against leakage of liquid fuel,
wherein the sealing arrangement comprises a first sealing interface of the first housing portion, and a second sealing interface of the attachment portion, and
wherein each of the first sealing interface and the second sealing interface comprise one or more respective interlocking portions configured to mutually engage with each other so as to form a seal against fluid communication.

2. The valve assembly of claim 1, wherein the attachment portion comprises an attaching interface including at least one outwardly-directed protrusion configured to couple the valve assembly to the wall of the fuel tank.

3. The valve assembly of claim 1, wherein the second housing portion includes one or more apertures, and
wherein the adaptor includes one or more retaining elements configured to respectively engage the one or more apertures so as to couple the first and second housing portions to each other in an assembled configuration of the housing.

4. The valve assembly of claim 1, wherein the adaptor includes one or more apertures, and
wherein the second housing portion includes one or more retaining elements configured to respectively engage the one or more apertures so as to couple the first and second housing portions to each other in an assembled configuration of the housing.

5. The valve assembly of claim 4, wherein the adaptor further includes one or more slots provided proximate to a corresponding aperture of the one or more apertures.

6. The valve assembly of claim 5, wherein each slot passes through a thickness of a wall of the adaptor.

7. The valve assembly of claim 4, wherein the adaptor further includes one or more cut-out portions each extending to a corresponding aperture of the one or more apertures.

8. The valve assembly of claim 4, wherein the adaptor further includes one or more pairs of longitudinal ribs each surrounding a corresponding aperture of the one or more apertures.

9. The valve assembly of claim 4, wherein the adaptor further includes one or more lateral ribs each disposed proximate to a side or edge of a corresponding aperture of the one or more apertures.

10. The valve assembly of claim 9, wherein at least one lateral rib of the one or more lateral ribs is interrupted by a slot or a cut-out portion of the adaptor.

11. The valve assembly of claim 1, wherein the one or more interlocking portions of the first sealing interface include a first projection and a second projection radially separated from each other via a first seal gap, and
wherein the one or more interlocking portions of the second sealing interface include a third projection and a fourth projection radially separated from each other via a second seal gap.

12. The valve assembly of claim 11, wherein a length of the first projection and a length of the second projection each extend from a base of the first seal gap to a respective tip of the first projection and the second projection, and
wherein a length of the third projection and a length of the fourth projection each extend from a base of the second seal gap to a respective tip of the third projection and the fourth projection.

13. The valve assembly of claim 12, wherein a width of the first seal gap is two times greater than a radius of curvature of the base of the first seal gap, and
wherein a width of the second seal gap is two times greater than a radius of curvature of the base of the second seal gap.

14. The valve assembly of claim 12, wherein the length of the first projection is equal to the length of the second projection, and
wherein the length of the fourth projection is greater than the length of the third projection.

15. The valve assembly of claim 14, wherein the length of the fourth projection is greater than the lengths of the first projection and the second projection.

16. The valve assembly of claim 14, wherein the length of the third projection is less than the lengths of the first projection and the second projection.

17. The valve assembly of claim 13, wherein, when the first sealing interface is separated from the second sealing interface, a width of the second projection is greater than the width of the second seal gap.

18. The valve assembly of claim 13, wherein, when the first sealing interface is separated from the second sealing interface, a width of the third projection is greater than the width of the first seal gap.

19. A fuel tank assembly, comprising:
a fuel tank; and
a valve assembly installed on the fuel tank, the valve assembly comprising:
a housing comprising:
a first housing portion including an outlet port and an adaptor, and
a second housing portion configured to be at least partially received within the adaptor so as to couple the first and second housing portions to each other, the second housing portion defining a fluid flow passage in fluid communication with the outlet port;
at least one valve component arranged within the housing, the at least one valve component configured to selectively close the fluid flow passage; and
an attachment portion directly coupled to the first housing portion through a sealing arrangement on a side opposite to the adaptor, the attachment portion configured to (i) couple the valve assembly to a wall of the fuel tank, and (ii) fluidly seal the valve assembly against leakage of liquid fuel,
wherein the sealing arrangement comprises a first sealing interface of the first housing portion, and a second sealing interface of the attachment portion, and
wherein each of the first sealing interface and the second sealing interface comprise one or more respective interlocking portions configured to mutually engage with each other so as to form a seal against fluid communication.

20. A method of coupling a valve assembly to a fuel tank, the valve assembly including an attachment portion, a first housing portion, and a second housing portion, the method comprising:
aligning the attachment portion with the first housing portion such that one or more interlocking portions of a first sealing interface provided on the first housing portion engages one or more respective interlocking portions of a second sealing interface provided on the attachment portion so as to form a seal against fluid communication;
aligning the first housing portion with the second housing portion such that at least one aperture of the first housing portion interlocks with at least one retaining element of the second housing portion so as to couple the first housing portion and the second portion to each other; and
attaching a weld pad of the attachment portion to an external support member via ultrasonic welding so as to couple the valve assembly to the fuel tank.
